(19) United States
(12) Patent Application Publication
(10) Pub. No.: US 2024/0386684 A1
(43) Pub. Date: Nov. 21, 2024

(54) DEVICE LOCATION SYNCHRONIZATION WITHIN A 3D STRUCTURE MODEL

(71) Applicant: Digs Space, Inc., Vancouver, WA (US)

(72) Inventors: Ryan R. Fink, Ridgefield, WA (US); Ty Frackiewicz, Ridgefield, WA (US)

(73) Assignee: Digs Space, Inc., Vancouver, WA (US)

(21) Appl. No.: 18/198,217

(22) Filed: May 16, 2023

(51) Int. Cl. G06T 19/20; G06T 7/80; H04N 7/18

(52) U.S. Cl. CPC G06T 19/20; G06T 7/80; H04N 7/183; G06T 2207/30204; G06T 2219/2004; G06T 2219/2016

(57) ABSTRACT

A digital model of a structure may be aligned with a device view of the structure using a location marker. In embodiments, the location marker may be an optical marker, a radio beacon, or one or more objects that can be recognized to a unique pattern. Device orientation information is used in conjunction with the location marker to align the digital model, so that the device can overlay one or more AR objects or other information on a view of the structure with relative precision. Other embodiments may be described and/or claimed.

### TECHNICAL FIELD

Disclosed embodiments are directed to augmented and virtual reality systems, and specifically to techniques for precisely locating a device within a structure for synchronizing with a digital model.

### BACKGROUND

Construction of a structure such as a house or commercial building involves input and/or contributions from a wide variety of different sources. Structures typically originate with a set of blueprints or similar plans which provide the basic dimensions of the building, and may specify various structural components. Such blueprints may be created by an architect and/or general contractor. The plans, or subsequent documentation from various subcontractors, can also include information about various building systems such as electrical, telecommunications, plumbing including water and sewage, and heating/ventilation/air conditioning (HVAC), to name a few trades. This collection of information can be useful over the life of its associated structure, to assist with maintenance and repairs, as well as aiding any subsequent modifications, renovations, and/or remodeling. As a result, such plans and documentation are typically kept safe so as to be available for the lifetime of the structure. With computer systems becoming ubiquitous, such information can increasingly be stored and managed in a digital format.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example system for providing a digital model of structure to a device that is synchronized with the device's position within the structure, according to various embodiments.

FIG. 2 depicts an example device displaying an image of a wall, with augmented reality features superimposed over the image illustrating hidden structures, according to various embodiments.

FIG. 3 depicts an example room within a structure that includes optical location markers, according to various embodiments.

FIG. 4 depicts an example room within a structure that includes radio frequency-based location markers, according to various embodiments.

FIG. 5 depicts an example room within a structure with a pattern of features that can serve as an optical location marker, according to various embodiments.

FIG. 6 depicts an example structure (illustrated as a floorplan) with a plurality of optical markers located throughout the structure corresponding to various locations within the structure, according to various embodiments.

FIG. 7 is a flowchart of the operations of an example method performed by a server for aligning a digital model corresponding to a structure with the position of a remote device within the structure, according to various embodiments.

FIG. 8 is a flowchart of the operations of an example method performed by a device for obtaining a digital model aligned with the device's location within a corresponding structure, according to various embodiments.

FIG. 9 is a block diagram of an example computer that can be used to implement some or all of the components of the disclosed systems and methods, according to various embodiments.

FIG. 10 is a block diagram of a computer-readable storage medium that can be used to implement some of the components of the system or methods disclosed herein, according to various embodiments.

### DETAILED DESCRIPTION

Mobile devices such as smartphones and tablets are typically equipped with a camera, a display, and one or more sensors that can detect a given device's orientation and movements. When so equipped, such a mobile device can provide an augmented reality (AR) experience, where a video stream of the device's physical surroundings is displayed on the display, and one or more digitally generated virtual objects can be placed within the video stream. Device motion information obtained from the one or more sensors can be used to continually update the location and orientation of the device relative to its surroundings, allowing the virtual objects to appear within the device display to be tied to a location in the physical surroundings. In other words, as the device is panned about the surroundings, the virtual objects appear as if placed at specific location(s) in the surroundings and so can move in and out of the camera frame in response to device motion, similar to real, physical objects in the surroundings.

Augmented reality technology offers practical benefits in a variety of settings, particularly when combined with technology to localize a device. For example, a smartphone equipped with a GPS can locate its position on a map, and use that positional information to retrieve information about various buildings and other points of interest in proximity to the device. A user of such a smartphone in a city may be able to use the smartphone's camera to view their surroundings, with the smartphone using AR objects to annotate various aspects of the surroundings. A building may have information overlaid upon it about the building's tenants, e.g. restaurants, businesses, etc. Points of interest such as public works of art may have information overlaid about the history and interesting facts about the points of interest.

Augmented reality may also be useful to provide information about hidden or obscured structures. Building plans may include information about building structures that are not visible once a building is completed. For example, structural members such as studs, joists, rafters, and trusses are typically covered by paneling or finishes such as drywall, siding, and trim when a building is completed. Likewise, structures such as HVAC runs, plumbing, and electrical cabling are also typically hidden from view by paneling or drywall. Being aware not just of the presence of such structures but also of their location is typically necessary before remodeling work can begin, to avoid possibly damaging such structures. Historically, such structures have been discovered typically by reference to plans (provided the plans are kept accurate) and/or by exploration or sensors, such as by using a stud finder or wall imager, or by making small exploratory cuts or holes to view inside walls. These techniques are not ideal, however, as stud finders and wall imagers may occasionally provide false readings (particularly if employed by an inexperienced user), and making exploratory cuts or holes results in wall or structural damage that must later be repaired, adding time and expense to a given project.

Thus, augmented reality may be able to obviate the need for imaging devices and/or exploratory cuts, by overlaying upon a wall graphic depictions of the locations of various structures, such as framing, wiring, duct runs, plumbing, etc. With AR technology, a user of a smartphone or similarly equipped mobile device may be able to image a wall or other building structure using the smartphone's camera and display, and have the smartphone superimpose the depictions of various hidden structures on the display. However, the usefulness of such depictions depends upon the precision with which they can be accurately overlaid on the visible building structures, viz. whether indications of the locations and positions of various structures are, in fact, correct with respect to the imaged building structure. In many cases, the indications must be precise to within a fraction of an inch (or better) to be meaningfully useful. For example, a user looking to install a bracket for mounting a large TV to a wall will need to bolt the bracket into wall studs, as a drywall anchors typically will not provide a sufficiently robust and safe mount. A typical wall stud is approximately 1.5″ (roughly 3.8 cm) in width when viewed from a wall, so a user will need to accurately locate the stud within a fraction of an inch (<1 cm) to ensure the mounting bolts are firmly secured into studs.

Disclosed embodiments are directed to techniques for accurately ascertaining the position of a mobile device, such as a smartphone, within a structure that has a corresponding database of information such as a digital model, so that the digital model can be precisely aligned to its corresponding physical structure features. When so aligned, AR information may be overlaid upon a view of the structure in the mobile device with high precision. In some embodiments, physical markers such as an optical tags and/or radio beacons may be placed at known locations about the structure, and be used as reference points for ascertaining a device's position within the structure for purposes of aligning and synchronizing views of AR objects from the structure's digital model. In other embodiments, other techniques may be employed, such as object recognition with reference to the digital model. Other embodiments may be described further herein.

In the following detailed description, reference is made to the accompanying drawings which form a part hereof wherein like numerals designate like parts throughout, and in which is shown byway of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

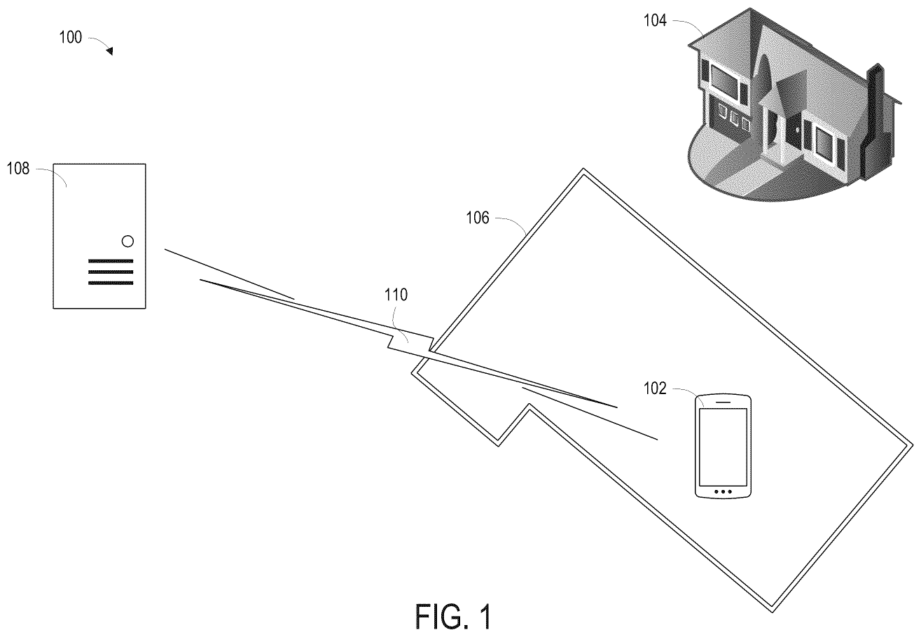

FIG. 1 illustrates an example system 100 with which the techniques and methods described herein can be deployed. System 100 includes a device 102, which may be in communication via a communication link 110 with a remote server 108. The device 102 may be located within a structure 106 that has a corresponding digital model 104. System 100 may be used to provide information to device 102 about structure 106 via augmented reality (AR) objects. The AR objects may be generated from information from the digital model 104, and may be overlaid upon a video feed of device 102 of the structure 106 that is displayed on a display of device 102.

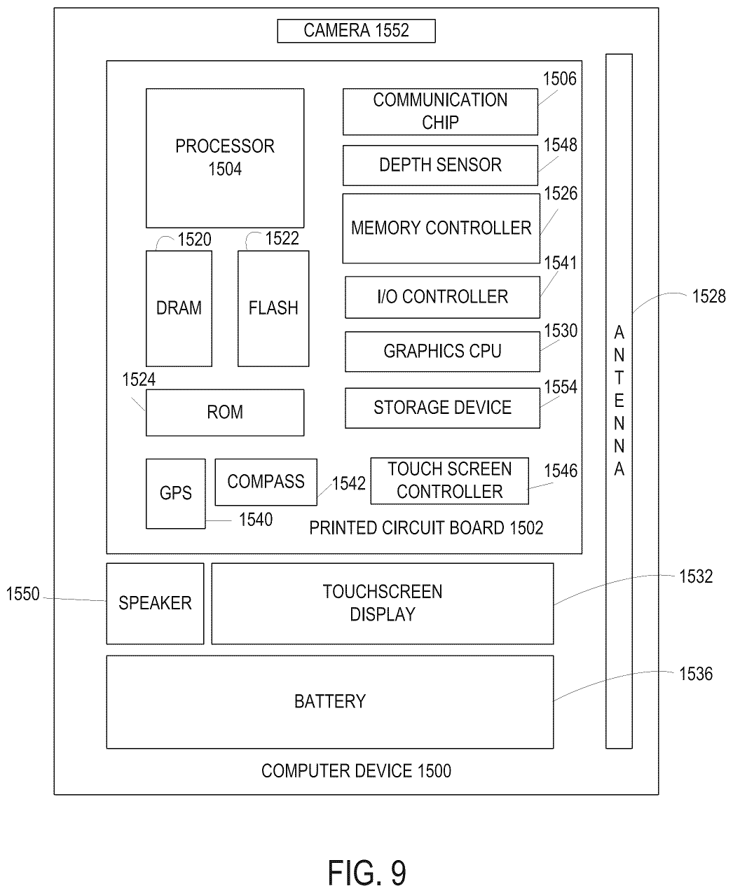

Device 102 may be any suitably equipped computing device, such as a computer device 1500 (FIG. 9, below). In embodiments, device 102 may be a mobile device, such as a smartphone, tablet, or laptop. Device 102 may be equipped with a camera, such as a video camera, that allows it to capture a video stream of its surroundings, as well as a display interface that can present video being captured by the camera as well as overlays, such as AR objects. Device 102 may further be equipped with one or more spatial orientation sensors that allow the movements of device 102 in space, e.g. linear and/or rotational movements, to be tracked and measured. This information from the one or more spatial orientation sensors can enable the camera pose of the camera equipped to device 102 to be determined and tracked as it changes with movements of the device 102. Device 102 may also be equipped with wireless network connectivity, such as WiFi, Bluetooth, LTE/5G, or another suitable networking technology that allows it to connect to and exchange data with a remote server, such as obtaining information for the generation of one or more AR objects.

In the depicted embodiment, device 102 is located inside of a structure 106. Although example structure 106 is illustrated in FIG. 1 as a two-dimensional floor plan for the sake of convenience, it should be understood that structure 106 is typically a three-dimensional structure, such as a house or office building. As such, structure 106 may include multiple rooms, and may have multiple floors, e.g. basement, ground floor, second story, third story, etc.; FIG. 1 only depicts one floor. Furthermore, disclosed embodiments may be employed in settings where structure 106 is other than a structure, such as an outdoor space, amphitheater, partial building, building under construction, open-sided or partially open structure such as a parking garage or gazebo, or a similar location. In this sense, structure 106 can be any location that can be defined with bounds or boundaries, even when such boundaries may be virtual, such as a geofence, provided that structure 106 can be associated with a digital model 104.

Structure 106 may have a corresponding digital twin, in the form of digital model 104. Digital model 104 is illustrated as a 3D rendering of a house, although digital model 104 may be at least partially implemented as a database or databases of information about structure 106. Digital model 104 may also have a corresponding 3D mesh or Digital model 104 may include information about various aspects of structure 106, such as structural information on framing, windows, and doors, information on plumbing, HVAC, electrical wiring, insulation, finishes, siding, landscaping, and/or any other aspects relevant to structure 106 and its construction. Digital model 104 may further include information about fixtures and appliances that may be contained within or otherwise associated with structure 106. Examples of such information include manuals about appliances, systems such as boilers, furnaces, water heaters, and air conditioners, lighting fixtures, plumbing fixtures, garage door openers, fireplaces, cabinets, flooring, etc. In some embodiments, digital model 104 may be periodically updated and/or amended, with changed or new information. For example, digital model 104 may be initially created from plans for a proposed structure 106 prior to structure 106 being physically built. In such an example, structure 106 may not exist, except as a predetermined location, and digital model 104 may provide a virtual representation or rendering of the yet-to-be-built structure 106.

Server 108 may be a remote server, and may communicate with device 102 at a remote location over communication link 110. Server 108 may be implemented using one or more computer devices 1500. In some embodiments, server 108 may be implemented as a cloud service that is Internet-accessible, or may be implemented as a data center that can be accessed via the Internet, a wide-area network (WAN), a metropolitan-area network (MAN), a local-area network (LAN), or some combination of the foregoing. Server 108, in system 100, may be in communication with one or more storage devices that may include some or all of the information for digital model 104. Server 108 may also be configured to determine the location of device 102 within structure 106, and provide portions of digital model 104 to device 102 in synchronization with the location of device 102, as will be discussed below.

Communication link 110, as mentioned above, may be any suitable connection for exchanging the data between device 102 and server 108 necessary to implement system 100 and the methods described herein below. Communication link 110 may be implemented using a wireless technology or wired technology, such as Ethernet, coaxial cable, or fiber optics, or a combination of wired and wireless technology. At least part of communication link 110 may be the Internet, in some embodiments.

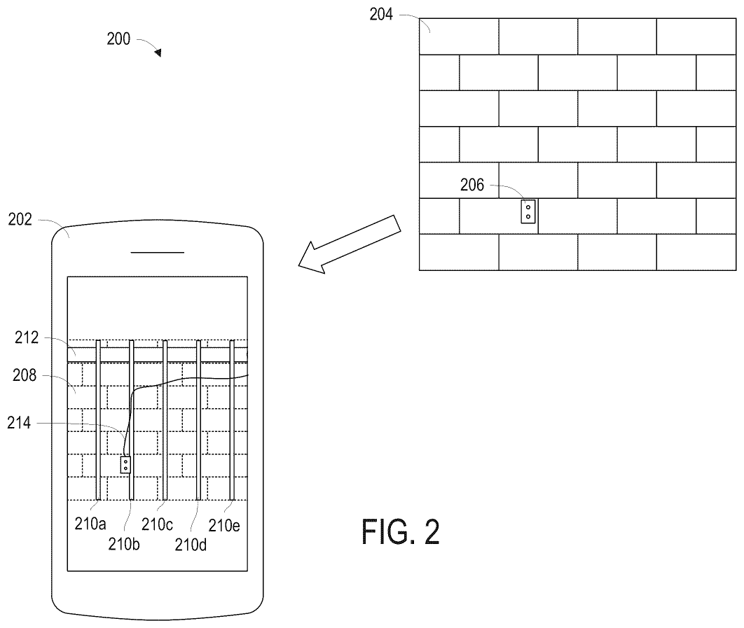

FIG. 2 illustrates an AR view 200 of a portion of a structure and an overlaid view generated from a corresponding digital model (or digital twin, terms used interchangeably). View 200 is illustrated on the display of a device 202, such as a smartphone, laptop, tablet, or other mobile device that is capable of displaying AR images. Device 202 may be an implementation of device 102 in system 100, described above with respect to FIG. 1. In some embodiments, device 202 may be a head-mountable or wearable system, such as smart glasses for an AR experience, or a virtual reality headset for a virtual reality (fully computer generated) experience. View 200 may be created by pointing the camera of the device 202 at a physical structure, such as wall 204, that has a corresponding structure or representation in a digital twin, such as structure 106 and digital model 104 described above with respect to FIG. 1. As will be discussed further below, wall 204 may have one or more externally visible markers such as a QR code, or structures such as an electrical outlet 206, that can be used by a system such as system 100 for synchronizing the location of device 202 within the structure with the structure's corresponding digital model. Wall 204 may enclose various structures so that they are not visible, but are known from the corresponding digital model.

When a user of device 202 is viewing a portion of wall 204, device 202 may be provided with information about various portions of, or related to, the wall 204 from the portion of the digital twin that corresponds to the view on the display of device 202. In the depicted embodiment, device 202 is viewing an AR-augmented representation 208 of wall 204, and accordingly may be provided information about structures hidden within wall 204, including structural members 210a to 210e, plumbing 212, and electrical cabling 214. The information may be obtained from the digital model and illustrated using AR objects overlaid upon the representation 208, which approximate the appearance of the structures. For example, structural members 210a to 210e, which may be studs, may be displayed as lumber in substantially the locations they would be found within the physical wall 204. Similarly, plumbing 212 and electrical cabling 214 may also be illustrated with AR objects that approximate the appearance and location of the physical plumbing and cabling to which the AR objects correspond. The locations of the AR objects superimposed upon wall 204 are synchronized from the digital twin to closely correspond with the locations of the actual structures within wall 204 that are represented by the AR objects.

It should be understood that, in embodiments, FIG. 2 depicts an AR implementation, where representation 208 is actual video of the wall 204 as captured by a camera connected to device 202. In such an implementation, structural members 210a to 210e, plumbing 212, and electrical cabling 214 may all be represented as AR objects overlaid on the video stream that provides representation 208. As is typical in AR implementations, the positions of the AR objects may move as device 202 moves, to give the appearance of the AR objects being tethered to the representation 208. However, in some embodiments the AR depiction may include a full digital representation of the structure including wall 204, similar to a virtual reality (VR) experience, such as when the structure has not yet been completed, or even started. The user's location within the digital twin may thus be synchronized to the location and orientation of device 202 within the structure, but with a wholly VR presentation provided through device 202 at approximately the location the structure will be completed, so that the user essentially moves through the computer-generated digital twin in synchronization with the user's movements through what would eventually be the corresponding physical structure.

In some embodiments, device 202 may receive the information for representation 208 from a remote server, such as server 108, or other repository of the digital twin and any associated information. For example, device 202 may transmit its location and orientation to the remote server, which may then correlate the location and orientation to the digital twin. The device 202 may further transmit information about its current view of the structure, such as a view portal or window size, so that the remote server can determine what portion and associated structures of the digital twin are currently in view of the device 202. With this information, the remote server can determine what information and/or AR objects from the digital twin to transmit to the device 202 for display, the information and AR objects corresponding to objects and structures currently in view of the camera of device 202. As will be understood, this information and/or AR objects will change and need to be updated as the current view of device 202 of the structure changes as device 202 is moved. Thus, in embodiments, the device 202 may continuously or repeatedly transmit motion data, which may include orientation data, camera intrinsics, and/or any other data related to camera position, to the remote server, so that the remote server may update the correlated location and orientation to the digital twin. The remote server may then transmit an updated or new set of AR objects tagged to the different portions of the digital twin that may come into view. This process may happen iteratively or continuously as the device 202 moves about the structure.

In other embodiments, device 202 may include a local copy of the digital twin, which may be accessed and/or displayed in a dedicated application that runs on device 202. In such embodiments, the device 202 may handle correlating its position and orientation within the local copy of the digital twin. Depending on the amount of information transmitted as part of the local copy, the device 202 may either generate any AR objects corresponding to the device 202's current view of the structure, or request the AR objects and/or information from the remote server with reference to the current position and view within the local copy of the digital twin. In still other embodiments, the device 202 may transmit its current view of the structure, such as a video stream, to the remote server. Depending upon the capabilities of device 202, in some embodiments the device 202 may further transmit to the remote server AR data such as depth information/3D point clouds, camera intrinsics, motion data, and/or any other data that can assist with the generation and placement of AR objects from the remote server.

Correspondence of the representation 208 of wall 204 with its appropriate location in the digital twin may be accomplished by the methods and embodiments described herein. In some embodiments, correlation or correspondence may be accomplished with reference to a video stream from device 202 as well as depth information, 3D point clouds, camera intrinsics, motion data, and/or other data types as mentioned above. For example, the detection of the presence and location of an electrical outlet 206 may be correlated with information from the digital twin, which, if the location of electrical outlet 206 is sufficiently unique, may allow an implementing system to ascertain the location of the device 202 within the physical structure. In other embodiments, a beacon or marker with a known position within the structure may be detected by device 202, which can then ascertain its distance and orientation from the known beacon or marker, and use this distance and orientation information to determine the location of device 202 within the physical structure. With this information, the representation 208 and any AR objects displayed on device 202 may be synchronized with the digital model, so that the representation 208 and any overlaid AR objects may correctly reflect the presence and location of actual structures found within wall 204.

It will be appreciated, in embodiments, that it may not be possible to precisely fix the location of device 202 within a structure that has a digital twin using object recognition when a given structure in view of device 202 has insufficient unique features to distinguish it from other locations within the structure. In other scenarios, certain unique features may be obscured by furniture or decorations, which may be moved from time to time. Conversely, where device 202 is used to access a digital twin of a structure that is still being built, some features may not yet be installed, depending upon what point the building is in the construction process. In either case, the location of device 202 within the structure may be unable to be initially synchronized. In such a scenario, a user of device 202 may be prompted to pan or otherwise move the device about the structure, until sufficient features can be detected or brought into view that the location of device 202 can be established. Alternatively or additionally, other possible embodiments for fixing the location of device 202 may be employed, such as GPS, triangulation with fixed wireless stations, detection of optical markers, generation of a 3D space from data from the device 202 and correlation with the digital twin, to provide a non-exhaustive list.

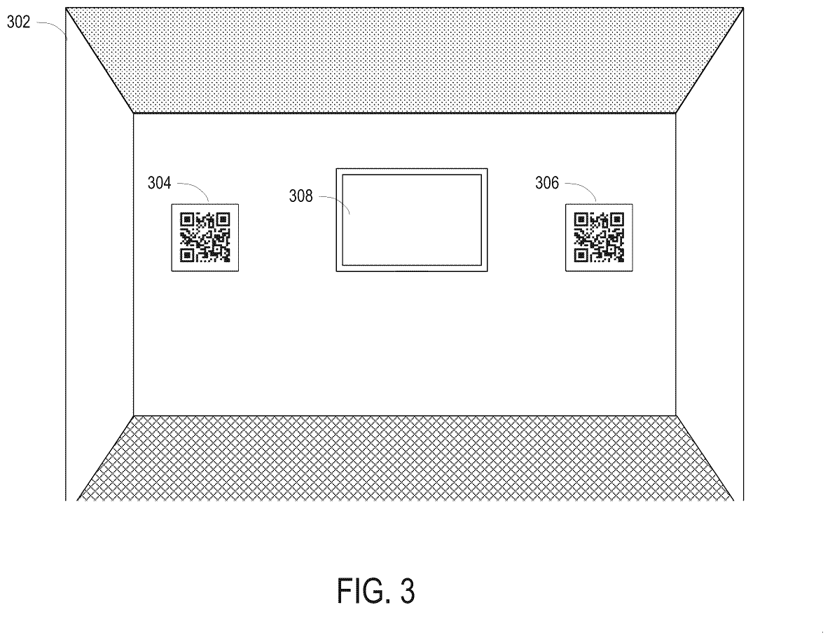

FIG. 3 depicts an example room 302 that includes a first optical target 304 and a second optical target 306, and a feature, window 308. The optical targets 304 and 306 may be used with a system, such as system 100, for determining the location and/or orientation of a device within a structure for synchronization with a digital model or digital twin. In the depicted embodiment, each of the optical targets 304 and 306 is placed within room 302 at a known and precise position within the room. Each optical target 304 and 306 may, in embodiments, have or be able to supply a code or other identifier that can uniquely identify the specific optical target against other optical targets that may be located within the structure. The position of each target along with each target's unique identifier are then provided to the implementing system. When the implementing system receives identification of one of the optical targets 304 or 306, it can retrieve the target's position and, in conjunction with orientation information about the device capturing the optical target, determine the location and orientation of the device within the structure.

Each of the optical targets 304 and 306 may be implemented using any suitable technique that allows for unique identification. In some embodiments, optical targets 304 and/or 306 may be implemented as QR codes, with the QR code encoding the optical target's unique identifier. In other embodiments, optical targets 304 and/or 306 may be implemented as a series of machine-readable numbers, symbols, a bar code, or any other suitable way of optically encoding or identifying the unique identifier. The location of each optical target 304 and 306 may be specified to a structure identified within the digital model that can also be accurately placed relative to a known object or point within the structure or within the room 302, in embodiments. For example, optical targets 304 and 306 may be tagged within the digital model to a predetermined position or distance from a feature such as window 308. The physical optical targets 304 and 306 may then be placed within room 302 at the corresponding position and distance from window 308, so that when a device acquires or images one of the optical targets 304 or 306, the position and orientation of the device can be determined relatively precisely from the acquired optical target. With this position and orientation, information from the digital model can be conveyed to the device, which may be superimposed as AR objects by the device on the view of the room 302 in positions that closely match their corresponding physical structures in room 302. Referring back to FIG. 2, for example, a representation of structural members 210a to 210e can be overlaid on a wall of the room 302 at positions that substantially correspond to where the physical structural members are located within the wall.

Depending on the specifics of a given embodiment, the device capturing the optical target 304 or 306 may decode the unique identifier and transmit it to a remote server storing/providing the digital model, or may simply send an image of the optical target to the remote server, with the remote server handling extraction and decoding of the identifier. Where the capturing device decodes the unique identifier, it should be understood that the capturing device will also need to supply sufficient information to the server providing the digital model to allow the server to determine the capturing device's position relative to the optical target. Such information can include the bearing and distance from the optical target, as well as device rotation and orientation. The capturing device may utilize any suitable technique for determining its position relative to the optical target, such as direct measuring of distance, photogrammetric techniques, use of camera intrinsics, or a combination of the foregoing. In other embodiments, the capturing device may provide an image of the optical target along with a decoded unique identifier. In still other embodiments, such as where the capturing device does not decode the unique identifier, the capturing device may simply send an image of the optical target to the server along with information sufficient to allow the remote server to determine the position of the capturing device relative to the optical target, e.g. camera intrinsics, depth information, etc. In yet further embodiments, the optical target may instead directly encode its positional information, obviating the need for the server to look up the optical target's location. Still further, a capturing device may be able to ascertain its position directly with respect to the optical target when the optical target encodes its position, which the device may be able to provide directly to the server.

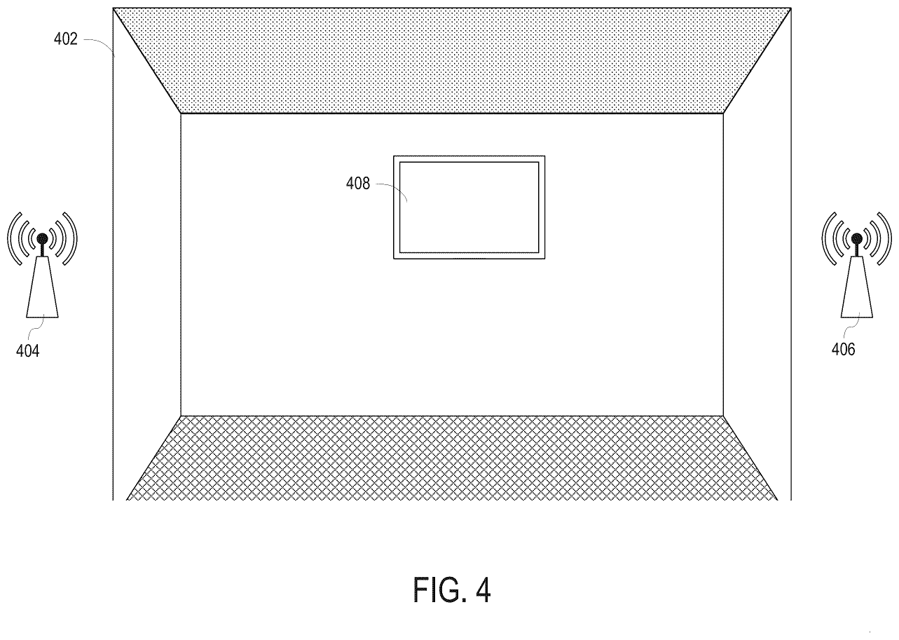

FIG. 4 depicts an example room 402 that includes a first radio beacon 404 and a second radio beacon 406. Similar to the optical targets 304 and 306 of FIG. 3, the radio beacons 404 and 406 may be used with a system, such as system 100, for determining the location and/or orientation of a device within a structure for synchronization with a digital model or digital twin. As with the optical targets, radio beacons 404 and 406 may be placed at precisely known locations within the structure enclosing room 402, such as with reference to the location of window 408. The radio beacons 404 and 406 are likewise tagged within the digital model that corresponds to room 402 at positions with reference to window 408 (or another suitable reference point), allowing the radio beacons to provide reference points for aligning a view of the digital model on the device with the corresponding physical structures of room 402. It will be observed that radio beacons 404 and 406 are illustrated as outside of room 402; the radio beacons 404 and/or 406 could be placed within or outside of room 402, provided their locations are known and the radio beacons 404 and/or 406 can be reached by a device to be located.

The radio beacons 404 and/or 406 may be implemented as WiFi access points or beacons, Bluetooth beacons, NFC tags, RFID tags, or any other suitable radio technology that can allow for transmission of a unique ID and can support ranging and azimuth determination. Similar to the optical targets of FIG. 3, each of the radio beacons 404 and 406 may transmit a unique ID when queried by a device, the unique ID allowing the position of the corresponding beacon to be retrieved by a server from the digital model. The unique ID may be any type of identifier that allows the beacon to be determined and its position retrieved. In some embodiments, as with the optical targets, the unique ID may instead encode the position of its corresponding beacon.

The selection of radio technology may, in some embodiments, depend at least partly upon the capabilities of the device to be located. For example, a device that is equipped with a diversity antenna configuration may be able to at least determine an azimuth from a radio station, and may, depending upon the device capabilities, be able to determine a distance from the station. Alternatively or additionally, a device may be able triangulate its position without distance information if it can determine its azimuth from at least two radio beacons, such as radio beacons 404 and 406. Along with device orientation information that may be determined from motion sensors equipped to the device (discussed above with respect to FIG. 1), the position of the digital model as viewed through the device can be aligned with the corresponding physical structures of room 402.

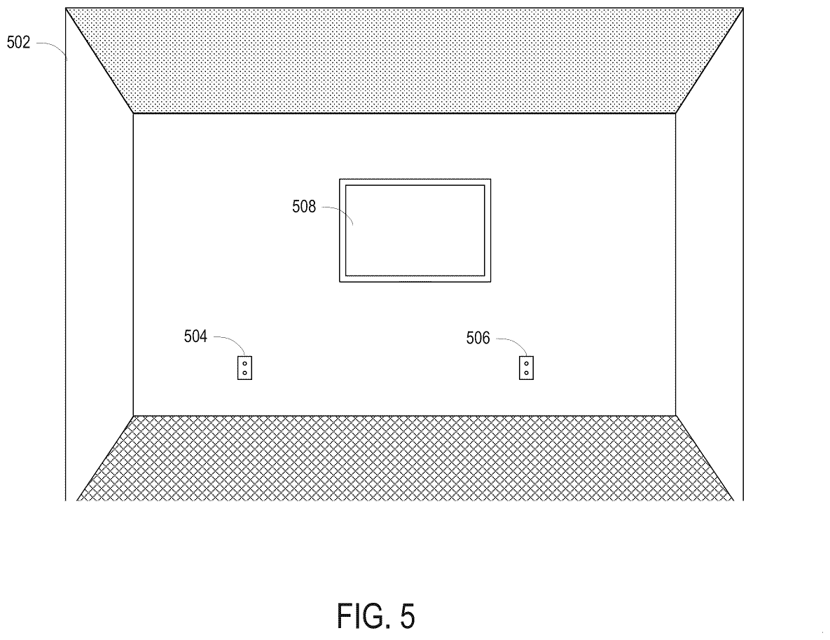

FIG. 5 depicts an example room 502 that includes several fixtures on its wall, including first socket 504, second socket 506, and window 508. The arrangement of the sockets 504 and 506, and window 508, may form a unique pattern that can be used to ascertain the location of the device within room 502. As with the optical targets of FIG. 3 and radio beacons of FIG. 4, the arrangement of fixtures may be used for determining the location and/or orientation of a device within a structure for synchronization with a digital model or digital twin.

In some embodiments, a capturing device may capture an image or video of the wall in room 502, and may perform one or more object detection algorithms on the image or video to detect and determine the position of each of the outlets 504 and 506, and window 508, within the image or video. These positions may then be transmitted to a server, which can use the arrangement of features (along with device orientation information, as discussed above), if sufficiently unique with respect to the digital model, to locate the position of the device within the structure. For example, the server may determine from the digital model that only one wall within the corresponding structure includes the particular number and arrangement of sockets and window, which, when combined with device orientation information, can allow the server to locate the device within room 502. It should be understood that a structure may have several walls with sockets and a window, but the specific positional relationship between outlets and socket may comprise a unique “fingerprint” that allows the wall in room 502 to be positively identified against other locations within the structure. In other embodiments, the capturing device may simply transmit the image or video to the server, with the server handling object detection and determination of device location.

It will be appreciated that, for the device to be located using object recognition, a sufficient number of objects must be detected so that a unique arrangement can be ascertained. Imaging a blank wall or a single outlet may be insufficient to allow determination of a unique location within the digital model and corresponding structure. In some embodiments, an implementing system such as system 100 (FIG. 1), may prompt a user of the device to move the device around until sufficient objects can be detected so as to locate the device within the room 502 (or any other room within the corresponding structure).

It should be understood that the precision with which a digital model or twin may be synchronized to the position of a device within the model's corresponding structure may depend on a variety of factors. For example the degree of error inherent in a device's sensors that may be used to determine device orientation can result in a relatively imprecise alignment. Similarly, imprecise camera intrinsic information, such as a slight mismatch between a device's reported camera focal length and actual focal length may introduce a positional error. Likewise, if an optical marker or radio beacon is imprecisely placed, digital model misalignment may occur. In some embodiments, an implementing system, such as system 100, may allow a user of a device being located to enter calibration information to help improve accuracy. In other embodiments, object recognition may be employed by the implementing system, similar to as depicted in FIG. 5, to improve the alignment of the digital model with its corresponding physical structures.

In some embodiments, a combination of markers and object recognition may be employed, e.g. several optical markers which may not be unique or distinct on their own may nevertheless be employed in a unique pattern or in combination with surrounding objects that are sufficient to uniquely and positively identify the location of the device. Likewise, a combination of optical markers and radio beacons, which may also include object recognition, may be employed. In some examples, optical markers and radio beacons may be selectively employed in different building locations depending upon the nature of the space, which may be better suited to one type of marker over another. For example, some rooms may be too small to support an optical marker, but could be served by one or more proximately located radio beacons. In other rooms, sufficient unique ornamentation may allow for locating a device using an object recognition technique.

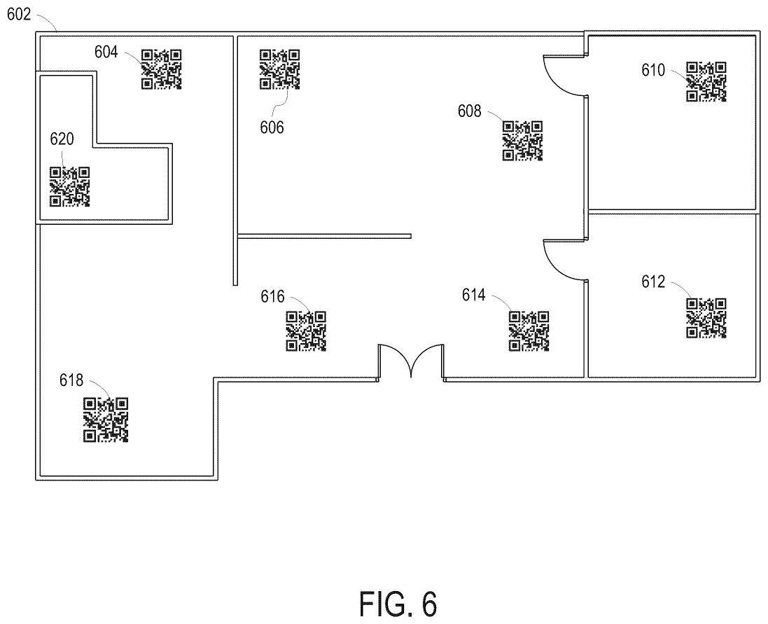

FIG. 6 illustrates an example floor plan of a building 602 with a plurality of optical markers 604 through 620 disposed about the building. Each of the different optical markers 604 to 620 corresponds with a different location within building 602. A device entering into building 602 can be localized within the building depending on which optical marker or markers are detected by the device. It should be understood that, although markers 604 to 620 are depicted as optical, the markers could be implemented as radio beacons. As described above with respect to FIGS. 3 and 4, each of the markers may encode a unique ID that corresponds to its particular location within building 602. In some locations, two markers may be disposed within a single room, such as optical markers 606 and 608, similar to the example depicted in FIG. 3, above. Multiple markers may be employed in a room that is sufficiently large such that a single marker would not provide a sufficiently accurate location at all places within the room. In some embodiments, the precision of location determination may decrease as a device gets further from a particular optical marker or radio beacon. Whether multiple markers are needed may depend upon the type of optical marker employed, and the extent to which a location of a device can be ascertained with acceptable precision at increasing distances from the marker.

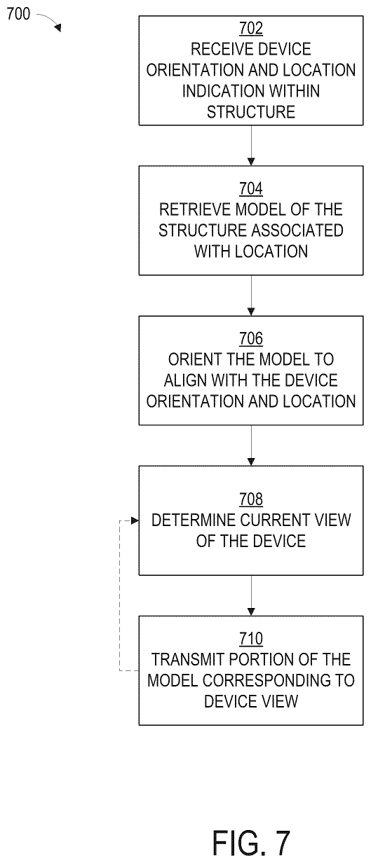

FIG. 7 is an example method 700 of the operations for aligning device's view of a digital model or twin with its corresponding structure view, upon receiving a device location and orientation. The operations of method 700 may be carried out in whole or in part, depending upon the needs of a given embodiment. Further some operations may be omitted, some operations may be added, and the order of operations may be rearranged depending upon the requirements of a given embodiment. The operations of method 700 may be carried out by one or more components of a system, such as system 100 (FIG. 1). Some or all operations may be carried out by a server, or by a device within the structure, or both.

In operation 702, a device orientation and location indication within a structure are received, for a device such as device 102 (FIG. 1). The device orientation may be provided by one or more spatial orientation sensors equipped to the device and may also include other information such as camera intrinsics, and the device location within the structure may be determined by detection of one or more optical markers, radio beacons, or object recognition, as described above with respect to FIGS. 3-6. As described above, the location indication may comprise a unique ID extracted from a marker or beacon, or may comprise an image of a marker or an arrangement of objects. The device orientation and location may be received at a server, such as server 108 (FIG. 1), which may handle some or all of computing the location and orientation of the device, depending upon the specifics of a given implementation.

In operation 704, a digital model or twin corresponding to the structure may be accessed, such as with reference to a unique ID obtained from an optical marker or radio beacon. In some embodiments, the device may provide a general geographic location, such as GPS coordinates, that may allow initial access to the digital model prior to receiving a unique ID. In other embodiments, the unique ID may be used to retrieve the digital model that corresponds to the structure. In embodiments, the digital model may be stored in a database or other data storage in communication with the server. In other embodiments, the digital model may be stored locally on the device, which may carry out some or all of the operations of method 700.

In operation 706, the location and orientation received in operation 702 are used to synchronize or align the digital model with the device's current position and orientation within the structure, as described above with respect to FIGS. 3-5.

In operation 708, the current view of the device is determined, such as from camera intrinsics and orientation data, which may be obtained from one or more spatial sensors coupled to the device. The view, in embodiments, corresponds to what the camera on the device is capturing of the structure, that may be displayed on a display of the device. The digital model is aligned to match the device's current view, such that features within the digital model appear to be positioned on top of or coterminous with their corresponding features in the structure, similar to the depiction in FIG. 2, above.

In operation 710, a portion of the digital model corresponding to the device view may be transmitted to the device, for potential rendering on the device's display. For example, structural members such as framing may be overlaid as AR objects upon a wall, similar to the depiction in FIG. 2, above. Appliances may be tagged with indicators informing a user of the device of the availability of additional information, such as appliance status, user manuals, service information, etc.

As shown by the dashed line between operations 708 and 710, operations 708 and 710 may be performed iteratively, with the device's view updated as the device moves throughout the structure. As the device moves, new information from the digital model may be transmitted to the device to correspond with the device's updated view. The device may render information as AR objects, so that the objects appear to move across the device's display in synchronization with the portions of the structure being viewed. Operations 708 and 710 may iterate continuously, substantially continuously, or on a predetermined update cycle until the communications session with the server is discontinued, or the view of the structure through the device is otherwise discontinued.

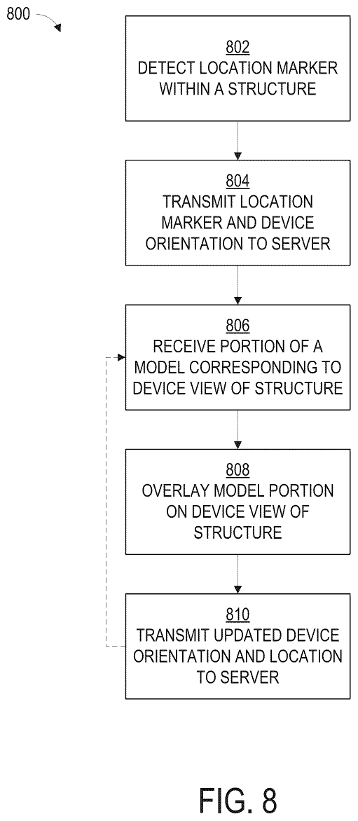

FIG. 8 is an example method 800 of the operations for determining the location and orientation of a device within a structure, for alignment with a corresponding digital model or twin, The operations of method 800 may be carried out in whole or in part, depending upon the needs of a given embodiment. Further some operations may be omitted, some operations may be added, and the order of operations may be rearranged depending upon the requirements of a given embodiment. The operations of method 800 may be carried out by one or more components of a system, such as system 100 (FIG. 1). Some or all operations may be carried out by a server, or by a device within the structure, or both.

In operation 802, a device, such as device 102 of system 100, may detect a location marker within a structure. The location marker may, in some embodiments, be one or more of the optical markers of FIG. 3, radio beacons of FIG. 4, and/or recognized objects of FIG. 5. As depicted in FIG. 6, the location marker may be tagged to a specific location within the structure.

In operation 804, the location marker, device orientation information, and/or device camera intrinsics may be transmitted to a server, such as server 108 of system 100. The location marker may be transmitted as an image, in some embodiments, or may be transmitted as a unique ID or combination of recognized objects in other embodiments. As described above, the device may decode the marker or beacon to obtain the unique ID, or may simply transmit an image of the marker (in the case of an optical marker of FIG. 3) or of the unique features of a portion of the structure (in the case of object recognition of FIG. 5), and allow the receiving server to extract the unique ID or detect objects. This location information may be used by the server to retrieve a digital model corresponding to the structure and align it with the device's view, as described above with respect to method 700 (FIG. 7).

In operation 806, a portion of the digital model corresponding to the device view of the structure may be received from the server, based on the location information and device orientation. The portion may comprise one or more AR objects, or may be information from which the device can generate AR objects for display on a device display, depending upon the embodiment.

In operation 808, the device may overlay some or all of the received portion of the digital model on its display, in the form of one or more AR objects, or possibly virtual reality objects. The nature of the displayed information may depend upon the specifics of a given embodiment. The display, in embodiments, may be comparable to the view depicted in FIG. 2.

In operation 810, the device may transmit updated orientation and/or location information to the server, in embodiments. As can be seen by the dashed line, operation 810 may iterate back to operation 806 as it moves through the structure. This updating allows the user of the device to view information from the digital model about different corresponding portions of the structure, as it transmits an updated location and orientation on a continuous, substantially continuous, or routine update basis.

It should be understood that some or all operations of method 800 may be carried out locally on the device, rather than in communication with a server, such as where the device includes a local copy of the digital model corresponding to the structure. In some embodiments, the server may simply transmit the digital model in its entirety in response to receiving a geographic location (such as GPS coordinates), and allow the device to then carry out the operations of methods 700 and 800 locally.

FIG. 9 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an 1/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of system 100, method 700, or method 800 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

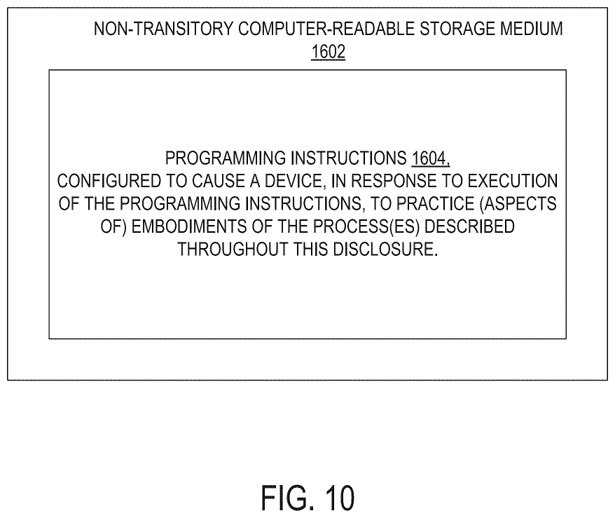

FIG. 10 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) method 700 or method 800 described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
receiving, at a server over a network, a location and orientation of a device within a structure;
retrieving, by the server, a model of the structure associated with the location of the device;
orienting, by the server, the model of the structure to align with the location and orientation of the device within the structure;
determining, by the server from the location and orientation of the device, a current view of the device; and
transmitting, to the device, a portion of the oriented model corresponding to the current view of the device.

2. The method of claim 1, wherein receiving the location and orientation of the device within the structure comprises receiving, at the server, an image of a location marker captured by the device, the location marker corresponding to the location.

3. The method of claim 2, further comprising:
extracting, from the image of the location marker, a unique identifier that is associated with the location; and
retrieving, by the server, the location.

4. The method of claim 3, wherein the image of the location marker is an image of a QR code.

5. The method of claim 1, wherein receiving the location and orientation of the device within the structure comprises:
receiving, at the server, a unique identifier that is associated with the location; and
retrieving, by the server, the location.

6. The method of claim 1, wherein receiving the location and orientation of the device within the structure comprises receiving, at the server, camera pose data and camera intrinsics about a camera coupled to the device.

7. The method of claim 1, wherein receiving the location and orientation of the device within the structure comprises receiving, at the server, a unique identifier corresponding to the location.

8. The method of claim 1, wherein receiving the location and orientation of the device within the structure comprises:
receiving, from the device, an image of the structure;
detecting, by the server, one or more objects from the image of the structure; and
determining, by the server, the location from the one or more detected objects.

9. A non-transitory computer readable medium (CRM) comprising instructions that, when executed by the processor of an apparatus, cause the apparatus to:
detect a location marker within a structure, the location marker associated with a location within the structure;
transmit, to a remote server, the location marker and an orientation of the apparatus;
receive, from the remote server, at least a portion of a digital model that is a representation of a portion of the structure that is in view of the apparatus, based on the location marker and the orientation; and
display, on display coupled to the apparatus, the portion of the digital model.

10. The CRM of claim 9, wherein to detect and transmit the location marker, the instructions are to further cause the apparatus to:
capture, with a camera coupled to the apparatus, an image of the location marker;
extract, from the image of the location marker, a unique identifier associated with the location within the structure; and
transmit the unique identifier to the remote server.

11. The CRM of claim 10, wherein the location marker comprises a QR code.

12. The CRM of claim 9, wherein to detect and transmit the location marker, the instructions are to further cause the apparatus to:
detect a radiofrequency beacon;
extract, from the radio frequency beacon, a unique identifier associated with the location within the structure; and
transmit the unique identifier to the remote server.

13. The CRM of claim 12, wherein the radio frequency beacon is a RFID tag, Bluetooth beacon, or WiFi hotspot.

14. The CRM of claim 9, wherein to detect and transmit the location marker, the instructions are to further cause the apparatus to:
capture, with a camera coupled to the apparatus, an image of one or more objects located within the structure; and
transmit the image of the one or more objects to the remote server.

15. The CRM of claim 9, wherein the instructions are to further cause the apparatus to:
transmit, to the remote server, an updated location and an updated orientation;
receive, from the remote server, an updated portion of the digital model in view of the apparatus based on the updated location and updated orientation; and
display, on the display, the updated portion of the digital model.

16. The CRM of claim 9, wherein the apparatus is a mobile device.

17. A non-transitory computer-readable medium (CRM) comprising instructions that, when executed by the processor of an apparatus, cause the apparatus to:
receive, over a network, a location and orientation of a remote device within a structure;
retrieve, from a storage device coupled to the apparatus, a model of the structure associated with the location of the remote device;
orient the model of the structure to align with the location and orientation of the remote device within the structure;
determine, from the location and orientation of the remote device, a current view of the device; and
transmit, to the remote device, a portion of the oriented model corresponding to the current view of the remote device.

18. The CRM of claim 17, wherein the instructions are to further cause the apparatus to:
receive, over the network, an updated location and updated orientation of the remote device within the structure; and
transmit, to the remote device over the network, an updated portion of the oriented model corresponding to an updated view of the remote device, the updated view determined from the updated location and updated orientation.

19. The CRM of claim 18, wherein the location of the remote device comprises a unique identifier extracted from a physical marker, and the instructions are to further cause the apparatus to determine a location of the remote device within the structure based on the unique identifier.

20. The CRM of claim 19, wherein the instructions are to further cause the apparatus to:
receive, from the remote device, an image of the physical marker; and
extract, from the image of the physical marker, the unique identifier.
